(19) United States
(12) Patent Application Publication
(10) Pub. No.: US 2022/0052495 A1
(43) Pub. Date: Feb. 17, 2022

(54) HANDLE SWITCH DEVICE

(71) Applicant: TOYO DENSO KABUSHIKI KAISHA, Tokyo (JP)

(72) Inventors: Yusuke TOMINAGA, Tsurugashima-shi (JP); Shingo MIYAYAMA, Tsurugashima-shi (JP); Tomoyuki TAJIMA, Tsurugashima-shi (JP)

(21) Appl. No.: 17/399,158

(22) Filed: Aug. 11, 2021

(30) Foreign Application Priority Data
Aug. 17, 2020 (JP) 2020-137554

(51) Int. Cl. H01R 13/70; B60L 53/12; H01R 13/52

(52) U.S. Cl. CPC H01R 13/70; H01R 2201/26; H01R 13/5213; B60L 53/12

(57) ABSTRACT

A handle switch device capable of preventing damage to a connection terminal. A handle switch device 10 mounted on a handlebar 11 of a vehicle 22 comprises a case-shaped switch housing 12 and a USB port 18 that supplies electric power to an external device. The USB port 18 is covered with an inner case 19 inside of the switch housing 12. The inner case 19 has a tubular opening 19a. The USB port 18 communicates with outside of the switch housing 12 through the opening 19a, and the USB port 18 is disposed on an inner side of the switch housing 12 rather than the opening 19a.

### BACKGROUND OF THE INVENTION

### Field of the Invention

The present invention relates to a handle switch device that is mounted on a handlebar of a vehicle.

### Description of the Related Art

In recent years, a mobile device, on which a navigation application is installed, is often used in a saddle riding type vehicle such as a two-wheel vehicle as a navigation device. However, since the navigation application is used continuously while driving the saddle riding type vehicle, there is a possibility that a charged capacity of a battery of the mobile device becomes zero due to an increase in electric power consumption.

Therefore, various methods for constantly supplying electric power from a battery or a generator of the vehicle to the mobile device while the navigation application is used, are suggested. For example, a method that a pipe-shaped charging adapter housing a transformer is mounted on the vehicle, the transformer is connected to a power supply of the vehicle, and the electric power is supplied to the mobile device from a connection terminal connected to the transformer via a power cord, is suggested (for example, see Japanese Laid-open Patent Publication (Kokai) No. 2017-159677).

Further, as a simpler method for neatly supplying electric power to a mobile device, a method that a USB port for supplying electric power is provided on a handle switch device mounted on a handlebar, is suggested by applicants of the present invention. In this method, the USB port is disposed inside of a switch housing and is connected to a USB connector.

However, in some cases, the handle switch device will be submerged due to rainfall, car washing, or the like. In this case, there is possibility that water that has entered the inside of the switch housing splashes on the USB port, a short circuit occurs in the USB port, and then the USB port will be damaged electrically.

Further, when the USB connector is slantingly connected to the USB port, a force is applied to the USB port from a direction different from a connection direction that is expected, and as a result, there is a risk that the USB port will be damaged physically such as the USB port is separated from a USB substrate.

### SUMMARY OF THE INVENTION

The present invention provides a handle switch device capable of preventing damage to a connection terminal.

Accordingly, an aspect of the present invention is to provide a handle switch device comprising a switch housing that is provided with switches, and a connection terminal that is provided in the switch housing and supplies electric power to an external device. The connection terminal is covered with an inner case inside of the switch housing. The inner case has a tubular opening. The connection terminal communicates with outside of the switch housing through the opening, and the connection terminal is disposed on an inner side of the switch housing rather than the opening.

According to the present invention, since the connection terminal that supplies electric power to the external device is disposed on the inner side of the switch housing rather than the tubular opening of the inner case that covers the connection terminal, when a connector is trying to be slantingly connected to the connection terminal from outside of the switch housing, the connector abuts on the opening of the inner case before the connector is connected to the connection terminal. As a result, no force is applied to the connection terminal from the direction different from the connection direction that is expected. Furthermore, by the connector moving along an inner surface of the opening, a moving direction of the connector is corrected toward the connection direction, as a result, when the connector is connected to the connection terminal, no unexpected force is applied to the connection terminal. Therefore, it is possible to prevent the damage to the connection terminal.

Further features of the present invention will become apparent from the following description of exemplary embodiments with reference to the attached drawings.

### BRIEF DESCRIPTION OF THE DRAWINGS

FIG. 1 is a perspective view that schematically shows an external appearance of a handle switch device according to an embodiment of the present invention.

FIG. 2 is a view for illustrating an arrangement state of an inner case in the handle switch device.

FIG. 3 is a perspective view for illustrating a positional relationship between a USB port and the inner case.

FIG. 4 is a plan view of the inner case.

FIG. 5 is a cross section view along a line V-V of FIG. 4.

FIGS. 6A, 6B and 6C are process drawings for illustrating a connection process of connecting a USB connector to the USB port.

FIGS. 7A and 7B are views for illustrating a positional relationship between various switches and an opening of the inner case in the handle switch device.

### DESCRIPTION OF THE EMBODIMENTS

Hereinafter, an embodiment of the present invention will be described in detail with reference to the drawings.

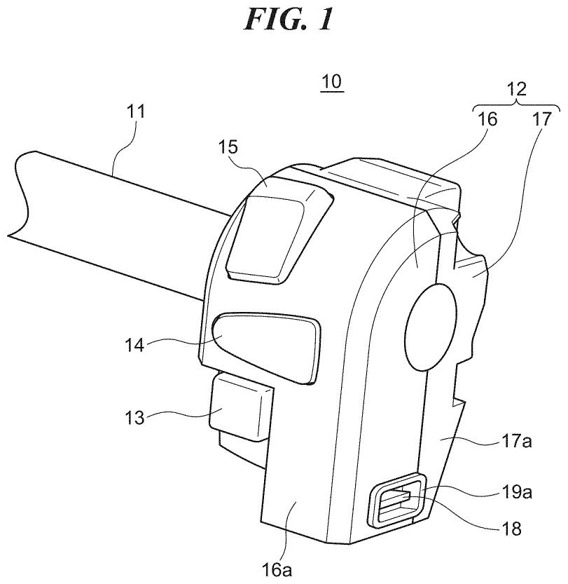

FIG. 1 is a perspective view that schematically shows an external appearance of a handle switch device 10 according to the embodiment of the present invention. As shown in FIG. 1, the handle switch device 10 includes a case-shaped switch housing 12 that is mounted on a cylindrical handlebar 11. The switch housing 12 has a front housing 16 that is disposed on a driver side with respect to a vehicle running direction and a rear housing 17 that is disposed on a side opposite to a driver with respect to the vehicle running direction.

For example, a winker switch 13, a horn switch 14 and a dimmer switch 15 that receive operation inputs of the driver are mounted on the front housing 16. Further, the front housing 16 and the rear housing 17 are fastened to each other by two screws (not shown) so that the handlebar 11 is sandwiched between the front housing 16 and the rear housing 17, and the front housing 16 and the rear housing 17 are mounted on the handlebar 11.

Furthermore, the handle switch device 10 includes a USB port 18 (hereinafter, also referred to as “a connection terminal”), which is a connection terminal that follows the USB (Universal Serial Bus) standard, and an inner case 19. The USB port 18 supplies electric power to an external device, for example, via a USB connector of a power cord of the connected external device. As the external device, to which the USB port 18 supplies electric power, for example, there are a small navigation device, an on-vehicle equipment for an electronic toll collection system, a mobile device such as a smartphone, an action camera, an intercom, a drive recorder, an altimeter and a heat warmer. A major part of the inner case 19 is housed inside of the switch housing 12, and is disposed at a lower part of the switch housing 12, specifically, is sandwiched between a front housing portion 16a of the front housing 16 and a rear housing portion 17a of the rear housing 17.

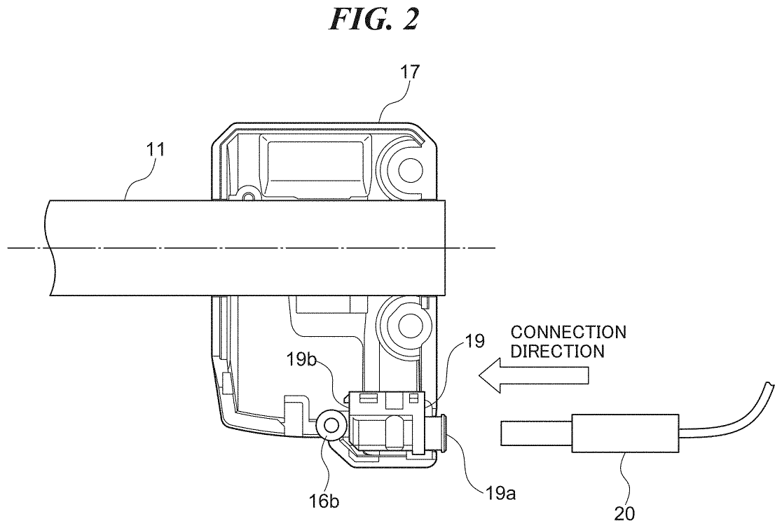

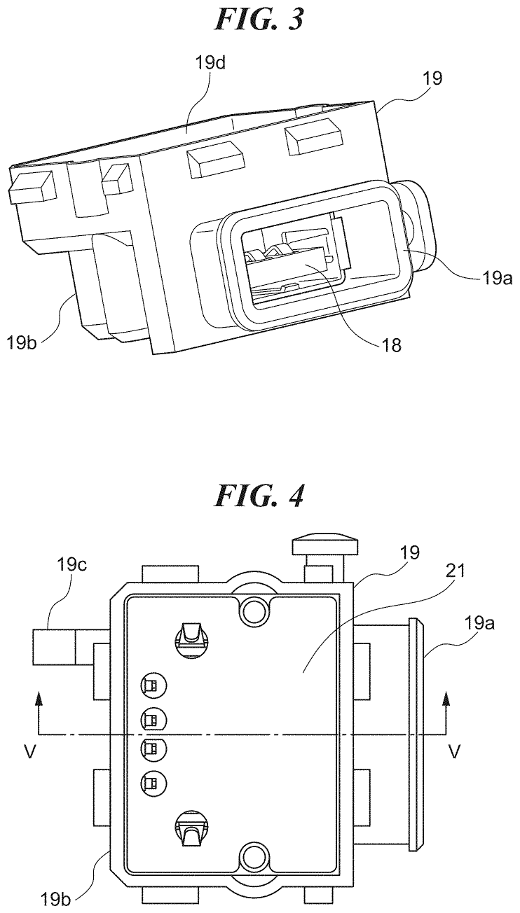

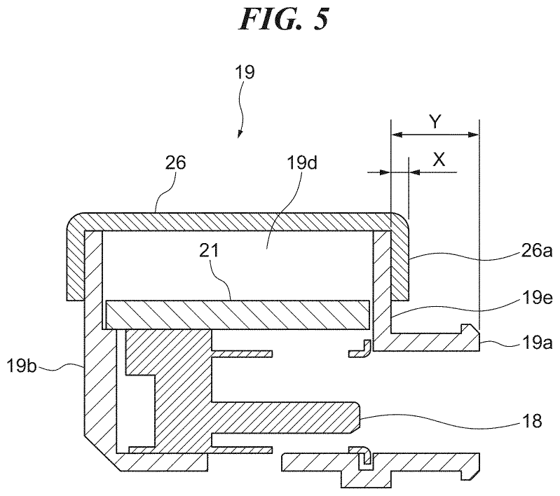

FIG. 2 is a view for illustrating an arrangement state of the inner case 19 in the handle switch device 10. In FIG. 2, in order to facilitate understanding, a part of a structure housed in the front housing 16 and the switch housing 12 is omitted. FIG. 3 is a perspective view for illustrating a positional relationship between the USB port 18 and the inner case 19. Further, FIG. 4 is a plan view of the inner case 19 and FIG. 5 is a cross section view along a line V-V of FIG. 4.

As shown in FIGS. 3 and 5, the inner case 19 is configured by a resin-made box body, and in the case that the inner case 19 is disposed the inside of the switch housing 12, the inner case 19 has an opening portion 19d at a portion positioned above. Further, the inner case 19 houses the USB port 18 and a USB substrate 21, on which the USB port 18 is disposed. Furthermore, in a state that the USB port 18, the inner case 19 and the USB substrate 21 are disposed the inside of the switch housing 12 and the handle switch device 10 is mounted on the handlebar 11, the USB port 18 and the inner case 19 are positioned below the handlebar 11.

The inner case 19 has a short tubular opening 19a on one side surface. In the handle switch device 10, the inner case 19 is disposed so that the opening 19a is exposed on a surface of the switch housing 12. When the inner case 19 houses the USB port 18, the USB port 18 faces the opening 19a straight and communicates with outside of the switch housing 12 through the opening 19a. Further, the USB port 18 is disposed on an inner side of the switch housing 12 rather than the opening 19a of the inner case 19.

The USB port 18 and the USB substrate 21 are fixed to the inner case 19, for example, by screws, and function as one rigid body. Further, the inner case 19 is fixed to the front housing 16 and the rear housing 17, for example, by screws. In particular, a side wall portion 19b of the inner case 19 that is on a side opposite to the opening 19a with respect to a connection direction of a USB connector 20, abuts on a boss 16b for screw provided on the front housing 16 and restricts a movement toward the connecting direction of the inner case 19. Furthermore, the side wall portion 19b has a flange 19c protruding toward the connecting direction of the inner case 19, and the flange 19c is fixed to the boss 16b of the front housing 16 by a screw or the like. As a result, it is possible to restrict the movement toward the connecting direction or a vertical direction in FIG. 2 of the inner case 19. Moreover, it is also possible to restrict the movement toward the vertical direction in FIG. 2 of the inner case 19 by making an upper surface and a lower surface of the inner case 19 abut on inner wall portions and protruding portions that are provided on the rear housing 17 and the front housing 16 without providing the flange 19c.

Further, the side wall portion of a front side (the side opposite to the driver) of the inner case 19 abuts on the inner wall portion (not shown) of the rear housing portion 17a of the rear housing 17, and the side wall portion of a rear side (the driver side) of the inner case 19 abuts on the inner wall portion (not shown) of the front housing portion 16a of the front housing 16. As a result, a movement of the inner case 19 with respect to the vehicle running direction is restricted. Moreover, in the present invention, a support member that abuts on the inner case 19 and supports the inner case 19 is not limited to the inner wall portions, the protruding portions and the boss that are described above, as long as it is a member that can restrict the movement of the inner case 19. The support member may be, for example, a rib or a flange within the switch housing 12.

Further, as shown in FIG. 5, an entire surface of the opening portion 19d of the inner case 19 is covered with an upper cover 26 that is a lid body. As a result, water that has entered the inside of the switch housing 12 is blocked by the upper cover 26 and does not splash on the USB port 18 and the USB substrate 21.

Furthermore, in a state that the handle switch device 10 is mounted on the handlebar 11, since the USB substrate 21 is disposed above the USB port 18, the USB substrate 21 is positioned above the opening 19a. Therefore, even in the case that water has entered the inside of the switch housing 12 from the opening 19a, the water will not splash on the USB substrate 21. As a result, it is possible to reliably prevent electrical damage to the USB substrate 21.

Further, the upper cover 26 has a wrap portion 26a that covers a part of a side wall portion 19e on the opening 19a side of the inner case 19. A protrusion amount X (hereinafter, referred to as “a first protrusion amount”) (see FIG. 5) of the wrap portion 26a from the side wall portion 19e of the inner case 19 is smaller than a protrusion amount Y (hereinafter, referred to as “a second protrusion amount”) (see FIG. 5) of the tubular opening 19a from the side wall portion 19e. As a result, it is possible to prevent water that splashes on the upper cover 26 and then flows downward through the wrap portion 26a from entering inside of the inner case 19 through the opening 19a.

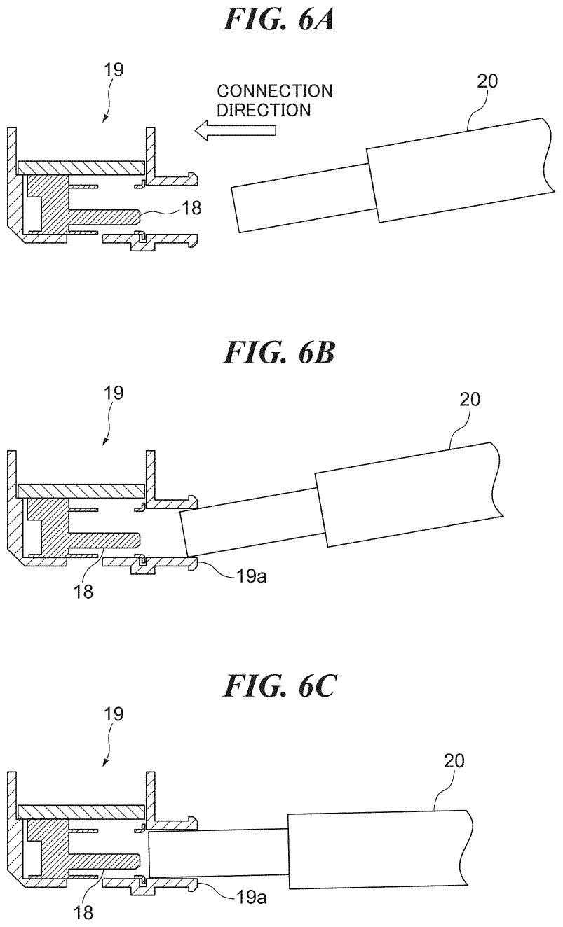

FIGS. 6A, 6B and 6C are process drawings for illustrating a connection process of connecting the USB connector 20 to the USB port 18. In the case of trying to connect the USB connector 20 to the USB port 18, when the USB connector 20 moves slantingly in the USB port 18 with respect to the connection direction (a lateral direction in FIGS. 6A, 6B and 6C) that is expected (FIG. 6A), an end of the USB connector 20 first abuts on an inner surface of the opening 19a of the inner case 19 (FIG. 6B).

After that, when the USB connector 20 is further moved toward the connection direction, the end of the USB connector 20 moves along the inner surface of the opening 19a, a moving direction of the USB connector 20 is corrected toward the connection direction (FIG. 6C), and the USB connector 20 is connected to the USB port 18 as it is.

As described above, since the USB port 18 and the USB substrate 21 are fixed to the inner case 19, and further the inner case 19 is fixed so that the movement toward the connecting direction of the inner case 19, the movement of the inner case 19 with respect to the vehicle running direction, and the movement toward the vertical direction of the inner case 19 are restricted, the inner case 19 and its peripheral portions function as one rigid body. As a result, as shown in FIGS. 6A, 6B and 6C, even in the case that the USB connector 20, which moves slantingly with respect to the connection direction, applies a load to the inner case 19, it is possible to prevent the inner case 19 from the occurrence of excessive deformation, damage, or the like.

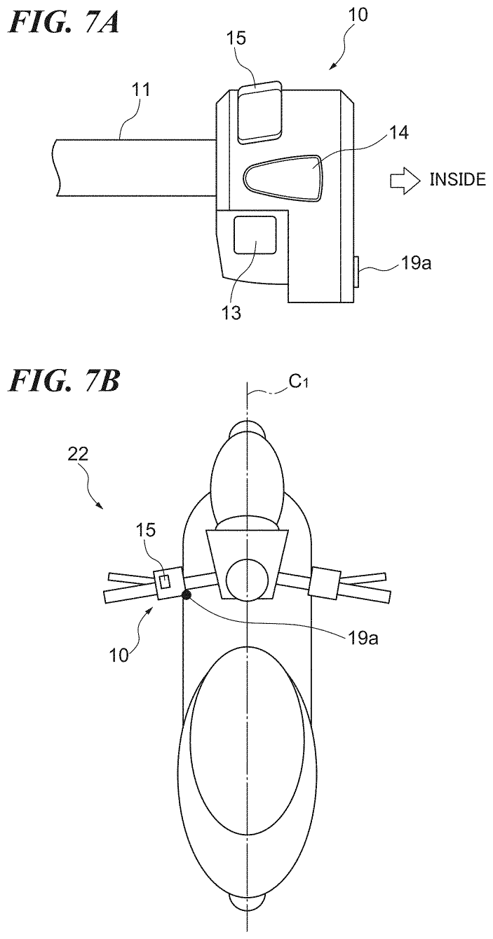

FIGS. 7A and 7B are views for illustrating a positional relationship between various switches 13 to 15 and the opening 19a of the inner case 19 in the handle switch device 10. As shown in FIG. 7A, in the state that the handle switch device 10 is mounted on the handlebar 11, the opening 19a is disposed closer to inside in a width direction of a vehicle 22 than the various switches 13 to 15, and the opening 19a is directed to the inside in the width direction of the vehicle 22. Here, in the embodiment, the inside in the width direction of the vehicle 22 means a center line Cl side of the vehicle 22 that is shown in FIG. 7B, and when the vehicle 22 is in a straight running state, that is, when the vehicle 22 is in a state that its handle is not turned, the opening 19a (the opening 19a is disposed at a position indicated by a black circle in FIG. 7B) is disposed closer to the center line Cl than any one of the various switches 13 to 15.

According to the embodiment, the USB port 18 that supplies electric power to the external device is disposed on the inner side of the switch housing 12 rather than the short tubular opening 19a of the inner case 19 that covers the USB port 18. As a result, in the case of trying to connect the USB connector 20 to the USB port 18, when the USB connector 20 moves slantingly with respect to the connection direction, the USB connector 20 abuts on the opening 19a of the inner case 19 before the USB connector 20 is connected to the USB port 18. Therefore, it is possible to avoid applying a force to the USB port 18 from a direction different from the connection direction. Furthermore, since the end of the USB connector 20 moves along the inner surface of the opening 19a, the moving direction of the USB connector 20 is corrected toward the connection direction, and the USB connector 20 is smoothly connected to the USB port 18. Therefore, when the USB connector 20 is connected to the USB port 18, no unexpected force is applied to the USB port 18. As a result, it is possible to prevent the physical damage to the USB port 18.

Further, in the embodiment, in the state that the handle switch device 10 is mounted on the handlebar 11, since the upper cover 26 cover an upper part of the USB port 18 and an upper part of the USB substrate 21, the water that has entered the inside of the switch housing 12 is blocked by the upper cover 26 and does not splash on the USB port 18 and the USB substrate 21. As a result, no short circuit occurs in the USB port 18 and the USB substrate 21, and it is possible to prevent the electrical damage to the USB port 18 and the USB substrate 21.

Furthermore, in the embodiment, since the inner case 19, to which the USB port 18 is fixed, abuts on the boss 16b, the flange 19c of the inner case 19 is fixed to the boss 16b, the side wall portion of the inner case 19 abuts on the inner wall portion of the front housing portion 16a and the inner wall portion of the rear housing portion 17a, when connecting the USB connector 20 to the USB port 18, the USB port 18 does not move. Therefore, it is possible to smoothly connect the USB connector 20 to the USB port 18.

Further, in the embodiment, the opening 19a of the inner case 19 is disposed closer to the inside in the width direction of the vehicle 22 than the various switches 13 to 15. When the driver operates the various switches 13 to 15, although the driver's finger touches the various switches 13 to 15 from outside of the vehicle 22, since the opening 19a is disposed closer to the inside in the width direction of the vehicle 22 than the various switches 13 to 15, the power cord of the USB connector 20 is routed the inside in the width direction of the vehicle 22 rather than the various switches 13 to 15. Therefore, since the power cord does not get entangled with the driver's finger, it is possible to improve an operability of the various switches 13 to 15.

Although the preferred embodiment of the present invention has been described above, the present invention is not limited to the above-described embodiment, and various modifications and changes can be made within the scope of the gist of the present invention.

For example, although the handle switch device 10, to which the present invention is applied, is mounted on the handlebar 11 on a left side of the vehicle 22, but the present invention may be applied to a handle switch device that is mounted on a handlebar on a right side of the vehicle 22.

Further, in the handle switch device 10, although the opening 19a of the inner case 19 is disposed closer to the inside in the width direction of the vehicle 22 than all the switches 13 to 15, the opening 19a may be disposed closer to the inside in the width direction of the vehicle 22 than at least one of the various switches 13 to 15.

Furthermore, in the handle switch device 10, although the opening 19a of the inner case 19 is directed to the inside in the width direction of the vehicle 22, a directivity direction of the opening 19a is not particularly limited, for example, the opening 19a may be directed downwardly.

Moreover, it is possible to apply the handle switch device 10 according to the embodiment to any vehicle that is provided with a handlebar, regardless of whether the handlebar is a bar-type handlebar or a separate type handlebar. For example, vehicles, to which the handle switch device 10 can be applied, are so-called saddle riding type vehicles. Further, the so-called saddle riding type vehicles include motorcycles, three-wheel vehicles and four-wheel vehicles that are classified as ATVs (All Terrain Vehicles), and snowmobiles. Furthermore, it is also possible to apply the handle switch device 10 to a small slide type saddle-riding vessel that is provided with a handle.

This application claims the benefit of Japanese Patent Application No. 2020-137554 filed on Aug. 17, 2020 which is hereby incorporated by reference herein in its entirety.

What is claimed is:

1. A handle switch device comprising:
a switch housing that is provided with switches; and
a connection terminal that is provided in the switch housing and supplies electric power to an external device, and
wherein the connection terminal is covered with an inner case inside of the switch housing,
the inner case has a tubular opening,
the connection terminal communicates with outside of the switch housing through the opening, and the connection terminal is disposed on an inner side of the switch housing rather than the opening.

2. The handle switch device according to claim 1,
wherein at least one switch is disposed in the switch housing, and
the opening is disposed inside in a width direction of a vehicle rather than the at least one switch.

3. The handle switch device according to claim 1 or 2,
wherein the connection terminal is fixed to the inner case, and
the inner case abuts on a wall portion of the switch housing.

4. The handle switch device according to claim 1 or 2,
wherein the connection terminal is fixed to the inner case, and
the inner case abuts on a boss of the switch housing.

5. The handle switch device according to claim 1 or 2,
wherein a connection terminal substrate, on which the connection terminal is disposed, is positioned above the opening.

6. The handle switch device according to claim 1 or 2,
wherein the connection terminal is fixed to the inner case,
when the inner case is disposed, the inner case has an opening portion at a portion positioned above, and
the opening portion is covered with a cover member.

7. The handle switch device according to claim 6,
wherein the inner case has a side wall portion, and
when the opening portion is covered with the cover member, a first protrusion amount of the cover member from the side wall portion is smaller than a second protrusion amount of the tubular opening from the side wall portion.
